(19) United States
(12) Patent Application Publication
(10) Pub. No.: US 2006/0268309 A1
(43) Pub. Date: Nov. 30, 2006

(54) Image forming apparatus and method

(75) Inventor: Kyoung-Jae Lee, Hwaseong-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/442,388

(22) Filed: May 30, 2006

(30) Foreign Application Priority Data
May 31, 2005 (KR) 2005-46116

(51) Int. Cl. G06F 3/12

(52) U.S. Cl. 358/1.13; 358/1.15

(57) ABSTRACT

An image forming apparatus and method are provided. The image forming apparatus includes an image processor for setting a display mode and print data according to the display mode, a user interface unit for receiving the display mode and displaying images of the print data, and an image forming unit for forming an image corresponding to a portion selected from the displayed images in the display mode. Therefore, even when a display mode in which images of print data are displayed is changed, a user does not need to perform onerous key manipulation for printing the image since an image corresponding to a portion selected from displayed print data can be directly printed when it is displayed in the changed display mode. Also, since images corresponding to print data changed according to a display mode and images corresponding to initially given print data can be used as images of a standby mode, it is unnecessary to change a display pattern which has already been displayed, in a standby mode, which is convenient for the users.

### CROSS-REFERENCE TO RELATED PATENT APPLICATIONS

This application claims the benefit under 35 U.S.C. §119(a) of Korean Patent Application No. 10-2005-0046116, filed on May 31, 2005, in the Korean Intellectual Property Office, the entire disclosure of which is hereby incorporated by reference.

### BACKGROUND OF THE INVENTION

1. Field of the Invention

The present invention relates to an image forming apparatus, such as a printer. More particularly, the present invention relates to an image forming apparatus and method for changing a display mode in which images corresponding to print data are displayed and directly printing the images when they are displayed in the changed display mode.

2. Description of the Related Art

Photo printers display images corresponding to photo data through display screens. The photo printers have a standby mode and an operating mode.

When a photo printer is in the standby mode, the photo printer displays images without changing a display mode in which the images are displayed. Meanwhile, when the photo printer is in the operating mode, the photo printer can zoom-in (or zoom-out) and display images according to a user's instruction. Also, the photo printer can display a plurality of images corresponding to photo data on a single screen according to a user's instruction when the photo printer is in the operating mode.

The photo printer prints displayed images. Specifically, when the photo printer displays a plurality of images on a single screen, a user can select one of the displayed images to be printed.

In this case, the photo printer cannot directly print the selected image when the plurality of images are displayed. That is, the conventional image forming apparatus is inconvenient because images corresponding to print data cannot be directly printed when they are displayed in the changed display mode when a display mode in which images of print data are displayed is changed.

Accordingly, there is a need for an improved system and method for providing an image forming apparatus which is capable of changing a display mode and directly printing images when they are displayed in the changed display mode.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an image forming apparatus which is capable of changing a display mode in which images corresponding to print data are displayed and directly printing the images when they are displayed in the changed display mode.

Another aspect of an exemplary embodiment of the present invention is to provide an image forming method capable of changing a display mode in which images corresponding to print data are displayed and directly printing the images when they are displayed in the changed display mode.

Still another aspect of an exemplary embodiment of the present invention is to provide a computer-readable recording medium storing a computer program for changing a display mode in which images corresponding to print data are displayed and directly printing the images when they are displayed in the changed display mode.

According to an aspect of an exemplary embodiment of the present invention, an image forming apparatus is provided. An image processor sets a display mode and print data according to the display mode. A user interface unit receives the display mode and displays images of the print data. An image forming unit forms an image corresponding to a portion selected from the displayed images in the display mode.

The given print data is initially given print data or print data processed according to a display mode, wherein the user interface unit can display the initially given print data or the processed print data. The image processor sets the display mode for increasing the number of images to be displayed together or sets the display mode for modifying the size of the image included in the selected portion.

The image forming apparatus also includes a storage unit which stores the initially given print data or the processed print data.

The user interface unit perceives a predetermined number of key manipulations performed according to a pre-set manipulation pattern. The user interface unit also receives the display mode by perceiving a display mode corresponding to the predetermined number of key manipulations as the display mode. A plurality of key manipulations or the predetermined number of key manipulations are performed to decide the display mode. Also, the number of the plurality of the key manipulations exceeds the predetermined number of the key manipulations.

The image forming unit prints the print data corresponding to the portion selected. The print data is image data.

According to another aspect of an exemplary embodiment of the present invention, an image forming method is provided. A display mode is set, at least one given print data is processed to display the print data according to the display mode and an image is formed corresponding to a portion selected from the displayed images in the display mode.

The display mode is set to increase the number of images to be displayed together or the display mode is set to modify the size of the image included in the selected portion. According to the image forming method, the initially given print data or the processed print data is stored, wherein the print data is the stored print data. The image is formed and the print data corresponding to the selected portion is printed.

According to still another aspect of an exemplary embodiment of the present invention, a computer-readable recording medium is provided to store a computer program for executing an image forming method. A display mode is set, at least one given print data is processed to display the print data according to the display mode and an image is formed corresponding to a portion selected from the displayed images in the display mode.

Other objects, advantages, and salient features of the invention will become apparent to those skilled in the art from the following detailed description, which taken in conjunction with the annexed drawings, discloses exemplary embodiments of the invention.

### BRIEF DESCRIPTION OF THE DRAWINGS

The above and other exemplary objects, features and advantages of certain exemplary embodiments of the present invention will be more apparent by describing in detail exemplary embodiments thereof with reference to the attached drawings in which:

FIG. 1 is a block diagram of an image forming apparatus according to an exemplary embodiment of the present invention; and

FIG. 2 is a flowchart illustrating an image forming method according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

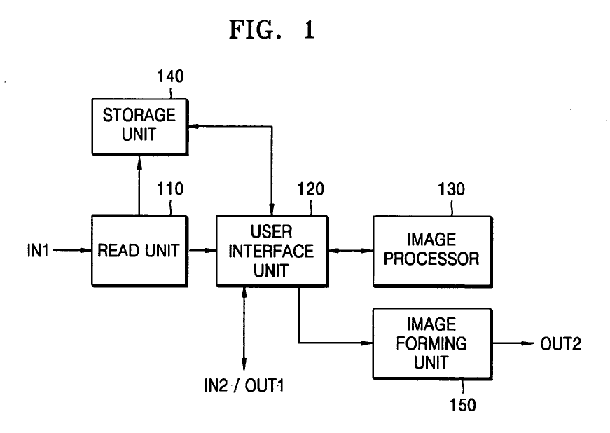

FIG. 1 is a block diagram of an image forming apparatus according to an exemplary embodiment of the present invention. Referring to FIG. 1, the image forming apparatus includes a read unit 110, a user interface unit 120, an image processor 130, and an image forming unit 140.

The image forming apparatus may be a photo printer or a multi function peripheral (MFP) comprising a print function.

The read unit 110 reads print data IN1 from a memory card which is installed in a memory card slot provided in the image forming apparatus.

The print data IN1 may be supplied from a host device installed in the image forming apparatus. In this case, the read unit 110 can be omitted.

Here, the print data IN1 includes at least one image which will be formed by the image forming apparatus according to an exemplary embodiment of the present invention. The print data IN1 is preferably image data, such as photo data. The print data IN1 may include a plurality of images.

The user interface unit 120 provides a user interface (not shown) to facilitate a user's selection of one of a plurality of available modes. In FIG. 1, a reference symbol OUT1 represents a user interface provided by the user interface unit 120.

The user interface displays images of the print data IN1. If the print data IN1 includes a plurality of images, the user interface can display the images so that a single image is displayed on a screen or so that N (N is a positive integer greater than 1) images selected from the plurality of the images are displayed on a screen.

The functions of the available modes are preferably pre-set. For example, a user can set a display mode (hereinafter, referred to as a “standby mode”) in which the user interface displays a single image on a single screen or a display mode (hereinafter, referred to as an “N-up mode”) in which the user interface displays N selected images on a single screen. A user can also set a display mode (hereinafter, referred to as a “zoom-in mode”) in which the user interface zooms-in and displays at least one image selected from a plurality of images or a display mode (hereinafter, referred to as a “zoom-out” mode) in which the user interface zooms-out and displays at least image one selected from a plurality of images. The above-mentioned N-up mode is a type of a zoom-out mode.

Other modes except for the standby mode are called operating modes.

The user can select one of the various display modes provided through the user interface and input the selected display mode (IN2 of FIG. 1) through the user interface. Therefore, the user interface unit 120 receives the selected display mode from the user.

The image processor 130 changes the display mode in which the images of the print data are displayed on the user interface to the selected display mode.

For example, if the selected display mode is the N-up mode, the image processor 130 increases the number of images that will be displayed together on the user interface N times.

Likewise, if the selected display mode is the zoom-in mode, the image processor 130 scales down the size of at least one image selected by a user among the images to be displayed on the user interface.

Also, if the selected display mode is the zoom-out mode, the image processor 130 scales up the size of at least one image selected by a user among the images to be displayed on the user interface.

If the display mode is changed by the image processor 130, the characteristic information of the print data varies inevitably. Here, the characteristic information includes information regarding the sizes of images of corresponding print data to be displayed on the user interface.

If the display mode is changed by the image processor 130, the user interface unit 120 displays the images of the print data in the changed display mode (OUT2 of FIG. 1) through the user interface.

If the user interface receives a 9-up mode from a user while the image processor 130 operates in a 4-up mode, the image processor 130 can enter the 9-up mode directly from the 4-up mode, instead of entering a stand-by mode from the 4-up mode and then entering the 9-up mode from the stand-by mode. That is, according to an exemplary embodiment of the present invention, mode conversion is performed without entering a stand-by mode.

Meanwhile, a user's key manipulation for selecting a display mode through the user interface is preferably hot-key manipulation. That is, when a predetermined number of key manipulations are performed according to a pre-set manipulation pattern, the user interface unit 120 perceives the key-manipulated result and receives a display mode corresponding to the key-manipulated result. A plurality of key manipulations or the predetermined number of key manipulations can be performed to decide a display mode. Preferably, the number of the plurality of the key manipulations exceeds the predetermined number of the key manipulations. Manipulation of the predetermined number of keys is called hot-key manipulation.

The storage unit 140 stores print data. At this time, information related to images of the print data is also stored in the storage unit 140. The storage unit 140 may be a hard disk drive (HDD).

The print data may be initially given print data or print data changed according to a display mode. The initially given print data is print data read by the read unit 110, and the changed print data is print data whose characteristic information is inevitably varied when an operating mode is changed.

Changed print data and initially given print data can be stored in the storage unit 140. In this case, the user interface unit 120 can display the images of the changed print data and the images of the initially given print data.

Print data stored in the storage unit 140 can be displayed anytime, and the print data can be changed according to an operating mode decided by a user. Accordingly, images of print data stored in the storage unit 140 are displayed on the user interface which is in a standby mode.

Since images of changed print data and images of initially given print data can be used as images of a standby mode, it is unnecessary to change a display pattern which has already been displayed, in a standby mode.

The image forming unit 150 forms an image corresponding to a portion selected from the images displayed on the user interface. For this operation, the image forming unit 150 can directly print the print data corresponding to an image selected among the displayed print data. In FIG. 1, a reference symbol OUT2 represents the formed image.

A plurality of images can be displayed on the user interface according to a display mode changed by the image processor 130, so that a user can instruct the user interface to selectively print at least one of the displayed images.

If the user interface receives a print instruction from the user, the image forming unit 150 can print only the selected image in the state that the plurality of the images are displayed in the changed display mode.

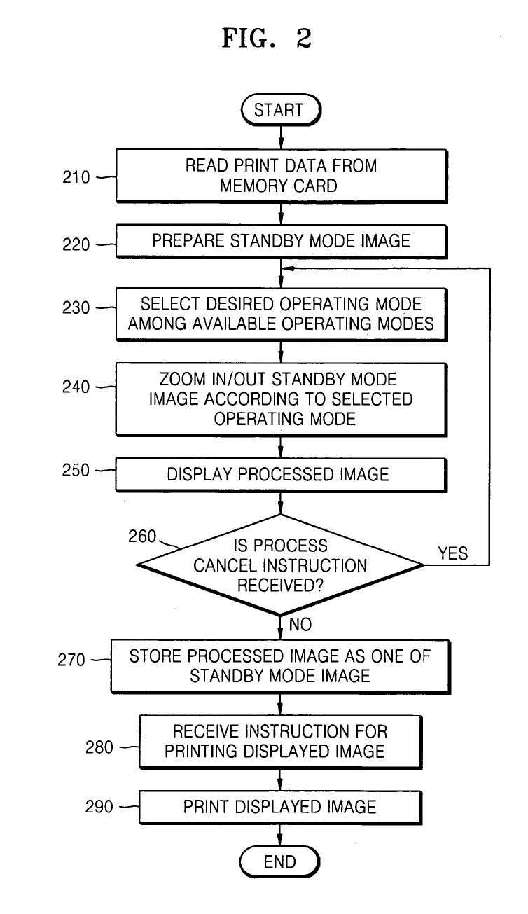

FIG. 2 is a flowchart illustrating an image forming method according to an exemplary embodiment of the present invention. According to an exemplary implementation of the image forming method, a display mode is changed in which images of print data are displayed (operations 210 through 240). Also, images of print data in the changed display mode are displayed and an image corresponding to a portion selected from the displayed images of the print data (operations 250 through 290) is formed.

A read unit 110 reads print data from a memory card which is installed in a memory card slot provided in an image forming apparatus (operation 210). Images of the read print data are stored as images of a standby mode in the storage unit 140 (operation 220). Here, the read print data is initially given print data.

A user interface unit 120 receives a display mode selected from available modes (operation 230). Here, the selected display mode may be a standby mode or an operating mode. For example, if the read print data has a plurality of images, the user interface unit 120 can receive a zoom-in mode or a zoom-out mode, among others.

If the user interface unit 120 receives an operating mode, an image processor 130 changes the display mode in which the images corresponding to the read print data are displayed, to the operating mode (operation S240).

The user interface unit 120 displays the images corresponding to the corresponding print data on a user interface (not shown) in the operation mode (operation 250).

After operation 250, the user interface unit 120 provides a user interface allowing a user to cancel the display mode.

If the user interface unit 120 receives a cancel instruction from the user (operation 260), the process proceeds to operation 230. If the user interface unit 120 receives no cancel instruction from the user (operation 260), the image processor 130 instructs the storage unit 140 to store the images corresponding to the changed display mode as images corresponding to a standby mode (operation S270).

The user interface unit 120 can display images of the read print data, images changed by the image processor 130, or images stored in the storage unit 140.

The user interface unit 120 receives a print command for printing an image corresponding to a portion selected among the displayed images from the user (operation 280), and an image forming unit 150 prints the corresponding image (operation 290).

An exemplary embodiment of the present invention can also be embodied as computer readable code on a computer readable recording medium. The computer readable recording medium is any data storage device that can store data which may be read by a computer system. Examples of the computer readable recording medium include read-only memory (ROM), random-access memory (RAM), CD-ROMs, magnetic tapes, floppy disks, optical data storage devices, and carrier waves. The computer readable recording medium may also be distributed over network coupled computer systems so that the computer readable code is stored and executed in a distributed fashion. In particular, functional programs, codes and code segments for executing an exemplary embodiment of the present invention may be easily deduced by programmers in the art.

In an image forming apparatus and method, according to an exemplary embodiment of the present invention, a user does not need to perform onerous key manipulation to print the image since an image corresponding to a portion selected from displayed images of print data can be directly printed in the state that they are displayed in the changed display mode. Onerous key manipulation is unnecessary even when a display mode is changed in which images corresponding to print data are displayed. Images corresponding to print data are changed according to the display mode and images corresponding to initially given print data can be used as images in a standby mode. Therefore, it is unnecessary to change a display pattern which has already been displayed, in the standby mode, which is convenient for the users.

While the present invention has been particularly shown and described with reference to certain exemplary embodiments thereof, it will be understood by those of ordinary skill in the art that various changes in form and details may be made therein without departing from the spirit and scope of the present invention as defined by the following claims and their equivalents.

What is claimed is:

1. An image forming apparatus comprising:
an image processor for setting a display mode and print data according to the display mode;
a user interface unit for receiving the display mode and displaying images of the print data; and
an image forming unit for forming an image corresponding to a portion selected from the displayed images in the display mode.

2. The image forming apparatus of claim 1, wherein the given print data comprises at least one of initially given print data and print data processed according to a display mode, wherein the user interface unit can display at least one of the initially given print data and the processed print data.

3. The image forming apparatus of claim 1, wherein the image processor sets at least one of the display mode for increasing the number of images to be displayed together and the display mode for modifying the size of the image comprised in the selected portion.

4. The image forming apparatus of claim 1, further comprising:
a storage unit for storing at least one of the initially given print data and the processed print data.

5. The image forming apparatus of claim 1, wherein the user interface unit perceives a result of hot-key manipulations and receives the display mode by perceiving a display mode corresponding to the result of hot-key manipulations as the display mode.

6. The image forming apparatus of claim 5, wherein the user interface unit perceives a number of key manipulations performed according to a pre-set manipulation pattern and receives the display mode by perceiving a display mode corresponding to the number of key manipulations as the display mode, and at least one of a plurality of key manipulations and the number of key manipulations are performed to decide the display mode, and the number of the plurality of the key manipulations exceeds the number of the key manipulations.

7. The image forming apparatus of claim 1, wherein the image forming unit prints the print data corresponding to the portion selected.

8. The image forming apparatus of claim 1, wherein the print data comprises image data.

9. An image forming method comprising:
setting a display mode;
processing at least one given print data to display the print data according to the display mode;
forming an image corresponding to a portion selected from the displayed images in the display mode.

10. The image forming method of claim 9, wherein at least one of the initially given print data and the processed print data is displayed.

11. The image forming method of claim 9, wherein the display mode is set for increasing at least one of the number of images to be displayed together and the display mode for modifying the size of the image comprised in the selected portion.

12. The image forming method of claim 9, further comprising:
storing at least one of the initially given print data and the processed print data, wherein the print data comprises the stored print data.

13. The image forming method of claim 9, wherein in the forming of the image, the print data corresponding to the selected portion is printed.

14. A computer-readable recording medium storing a computer program for executing an image forming method comprising:
setting a display mode;
processing at least one given print data to display the print data according to the display mode; and
forming an image corresponding to a portion selected from the displayed images in the display mode.
